(19) United States
(12) Patent Application Publication
(10) Pub. No.: US 2025/0183320 A1
(43) Pub. Date: Jun. 5, 2025

(54) COATED ELECTRODES

(71) Applicant: Tesla, Inc., Austin, TX (US)

(72) Inventors: Allen Pei, Sunnyvale, CA (US); Gang Yang, Los Gatos, CA (US)

(21) Appl. No.: 18/840,776

(22) PCT Filed: Mar. 7, 2023
(86) PCT No.: PCT/US2023/014729

§ 371 Date: Aug. 22, 2024

Related U.S. Application Data
(60) Provisional application No. 63/318,081, filed on Mar. 9, 2022.

(51) Int. Cl. H01M 4/66; H01M 4/02; H01M 4/1393; H01M 4/62; H01M 4/70; H01M 10/0525

(52) U.S. Cl. CPC H01M 4/664; H01M 4/1393; H01M 4/622; H01M 4/663; H01M 4/667; H01M 4/70; H01M 2004/021; H01M 10/0525

(57) ABSTRACT

The present disclosure relates to insulating electrode edge coating compositions and methods of making the same. Energy storage devices, such as a lithium ion battery, utilizing the insulating coating compositions are also described.

### INCORPORATION BY REFERENCE TO ANY PRIORITY APPLICATIONS

This application claims priority to U.S. Prov. Patent App. No. 63/318,081 titled “COATED ELECTRODES” and filed on Mar. 9, 2022, the disclosure of which is hereby incorporated herein by reference in its entirety.

### BACKGROUND

### Field

The present disclosure relates to energy storage devices and methods of making thereof. More specifically, the present disclosure relates to insulating electrode edge coating compositions and methods of making and using the same.

### Description of the Related Art

Many types of battery cells are currently used as energy sources in electric vehicles and energy-storage applications. Many current cells use a jelly-roll design in which the cathode, anode, and separators are rolled together and have a cathode tab and an anode tab to connect to the positive and negative terminals of the cell can.

The path of the current necessarily travels through these tabs to connectors on the outside of the battery cell. However, ohmic resistance is increased with distance when current must travel all the way along the cathode or anode to the tab and out of the cell. Furthermore, because the tabs are additional components, and add additional thickness to the device and must themselves be rolled into the jellyroll, they can increase costs and present manufacturing challenges.

### SUMMARY

For purposes of summarizing the invention and the advantages achieved over the prior art, certain objects and advantages of embodiments of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a coated electrode foil is described. The coated electrode foil includes: a foil including a first portion, a second portion and a third portion; a carbon coating disposed over the first portion of the foil; and an insulating layer disposed over the second portion of the foil, wherein the insulating layer includes: a ceramic material including a D50 particle size distribution range from about 1 nm to about 500 nm; and a high glass transition temperature binder.

In some embodiments, the high glass transition temperature binder has a glass transition temperature of at least about 140° C. In some embodiments, the ceramic material comprises a powder selected from the group consisting of an alumina powder, a boehmite powder, and combinations thereof. In some embodiments, the ceramic material comprises a D50 particle size distribution range from about 0.1 μm to about 0.3 μm. In some embodiments, the binder comprises of at least one of polyvinylpyrrolidone (PVP), poly(N-vinylcaprolactam) (PNVCL), poly(vinyl pyrrolidone-co-caprolactam), poly(n-vinylacetamide) (PNVA), ethylene-acrylic acid (EAA), or polyglycidyl ether.

In another aspect, an electrode is described including: a coated electrode foil of the present disclosure; and an electrode film disposed over the first portion of the foil. In some embodiments, the third portion of the coated electrode foil comprises a series of flags. In some embodiments, the electrode is in a wound configuration and the series of flags are substantially interleaved. In some embodiments, the series of flags form a concentric circular pattern. In some embodiments, the distance between the series of flags ranges from 5 mm to 50 mm. In further embodiments, the distance between the series of flags ranges from 5 mm to 20 mm. In some embodiments, the electrode further comprises a gap disposed between the electrode film and the insulating layer.

In another aspect, an energy storage device is described including: an electrode of the present disclosure; a second electrode; and a separator disposed between the electrode and second electrode; an electrolyte; and a housing, wherein the electrode, second electrode, separator and electrolyte are disposed within the housing. In some embodiments, the electrode is a cathode and the second electrode is an anode.

In another aspect, a method of preparing an electrode is described. The method includes: coating a foil comprising a first portion and a second portion with an insulating layer over the second portion to form a coated electrode foil, wherein a carbon coating is disposed over the first portion of the foil; disposing an electrode film over the coated electrode foil, wherein a portion of the electrode film is disposed over the insulating layer; and removing the portion of the electrode film disposed over the insulating layer to form an electrode.

In some embodiments, the portion of the insulating layer comprises a smooth surface after the portion of the electrode film is removed. In some embodiments, the portion of the electrode film cleanly peels from the insulating layer during the disposing and removing steps. In some embodiments, the method further comprises visually identifying the boundary of the electrode film and forming a counter electrode with an overhang extending beyond the electrode.

In another aspect, an insulating material is described. The insulating material includes: a ceramic material comprising a D50 particle size distribution range from about 1 nm to about 500 nm; and a high glass transition temperature binder.

In some embodiments, the ceramic material comprises a D50 particle size distribution range from about 0.1 μm to about 0.3 μm.

In another aspect, a method of preparing an electrode is described. The method includes: coating a foil comprising a first portion and a second portion with an insulating layer over the second portion to form a coated electrode foil, wherein a carbon coating is disposed over the first portion of the foil; and disposing an electrode film over the first portion of the foil and the carbon coating to form an electrode.

In some embodiments, the method further comprises cutting the electrode film prior to disposing the electrode film over the first portion of the foil and the carbon coating. In some embodiments, coating the foil comprises disposing an aqueous insulating solution over the second portion. In some embodiments, the method further comprises forming a gap disposed between the electrode film and the second portion. In some embodiments, the method further comprises identifying the gap and forming a counter electrode with an overhang extending beyond the electrode.

### BRIEF DESCRIPTION OF THE DRAWINGS

FIG. 1A illustrates the coating pattern of the coated electrode foil, according to one embodiment.

FIG. 1B is an expanded view of FIG. 1A illustrating the coating pattern of the coated electrode foil, according to one embodiment.

FIG. 2A shows a perspective view of a battery cell can.

FIG. 2B shows a side view of the battery cell can of FIG. 2A.

FIG. 3 shows a perspective view of the material layers within a jellyroll, according to one embodiment.

FIG. 4 shows a cross-sectional view of a terminal end of a jellyroll, according to one embodiment.

FIG. 5A illustrates a terminal end of a coated electrode foil with an edge coating, according to one embodiment.

FIG. 5B is an expanded view of FIG. 5A illustrating a terminal end of a coated electrode foil with an edge coating, according to one embodiment.

FIG. 6 illustrates the cross-sectional view of the coating pattern of the coated electrode foil, according to one embodiment.

FIG. 7 is a flowchart of a process for preparing an electrode, according to one embodiment.

FIG. 8 is a flowchart of a process for preparing an electrode, according to one embodiment.

FIG. 9A is a scanning electron microscope (SEM) image of a typical solvent-based ceramic slurry mingling with a solvent-based cathode slurry.

FIG. 9B is a top view photographic image of a solvent-based ceramic slurry mingling with a solvent-based cathode slurry.

FIG. 10 is a line graph of the electrolyte uptake factor of aged electrolytes with crosslinked and uncrosslinked binders.

FIG. 11 is a line graph showing the current v. voltage of electrodes with and without the presently disclosed ceramic material and crosslinked binder.

FIG. 12 is a graph showing the DSC curves of crosslinked and uncrosslinked binders.

FIG. 13 is a graph of various ceramic particles cohesion strengths as a function of the binder percentage.

FIG. 14 is a graph of various ceramic coating adhesion strengths as a function of binder percentage.

FIG. 15A is a scanning electron microscope (SEM) image of a typical insulating layer.

FIG. 15B is an expanded view of FIG. 15A of a scanning electron microscope (SEM) image of a typical insulating layer.

FIG. 15C is an expanded view of FIG. 15B of a scanning electron microscope (SEM) image of a typical insulating layer.

FIG. 15D is a scanning electron microscope (SEM) image of an insulating layer, according to one embodiment.

FIG. 15E is a compacted view of FIG. 15D of a scanning electron microscope (SEM) image of an insulating layer, according to one embodiment.

FIG. 15F is an expanded view of FIG. 15E of a scanning electron microscope (SEM) image of an insulating layer, according to one embodiment.

FIG. 16A is a scanning electron microscope (SEM) image of an insulating layer, according to one embodiment.

FIG. 16B is an expanded view of FIG. 16A of a scanning electron microscope (SEM) image of an insulating layer, according to one embodiment.

FIG. 17A is a scanning electron microscope (SEM) image of an insulating layer, according to one embodiment.

FIG. 17B is an expanded view of FIG. 17A of a scanning electron microscope (SEM) image of an insulating layer, according to one embodiment.

FIG. 18A is an image of delamination results of an electrode active material layer utilizing a typical insulating layer.

FIG. 18B is an image of delamination results of an insulating layer utilizing a typical insulating layer.

FIG. 19A is an image of delamination results of an electrode active material layer utilizing an insulating layer, according to one embodiment.

FIG. 19B is an image of delamination results of an insulating layer utilizing an insulating layer, according to one embodiment.

FIG. 20 is an image of a lamination result utilizing an insulating layer with ammonium polyacrylate as a dispersant.

FIG. 21A is a photographic image of a coated cathode electrode with a gap between the electrode film and an insulating layer, according to one embodiment.

FIG. 21B is an expanded view of FIG. 21A of a photographic image of a coated cathode electrode with a gap between the electrode film and an insulating layer, according to one embodiment.

### DETAILED DESCRIPTION

The present disclosure relates to an insulating material for use in electrodes within an energy storage device. The insulating material may be applied to the edge of an electrode layer as an edge coating to result in an edge-coating insulating layer. The edge-coating insulating layer may facilitate improved charging and discharging cycles. In addition, when fabricating the electrode, the edge coating insulating layer of the present disclosure cleanly peels from an electrode active material layer. In some embodiments, there is no, or substantially no, intermingling of the insulating layer or ceramic coating and electrode or electrode film.

In some embodiments, the insulating material of the present disclosure is coated onto an electrode or a coated electrode foil. In some embodiments, the coated electrode foil comprises an electrode foil and a carbon coating disposed over a portion of the electrode foil. In some embodiments, the insulating material functions as a dividing film between different electrodes. In some embodiments, the insulating material provides electrical insulation to an anode and/or a cathode. In some embodiments, the insulating material disposed on a coated electrode foil does not stick or adhere to an electrode film during the lamination process.

Reference will now be made in detail to specific aspects or features, examples of which are illustrated in the accompanying drawings. Wherever possible, corresponding or similar reference numbers will be used throughout the drawings to refer to the same or corresponding parts.

### Insulating Layer

The insulating layer of the present disclosure may comprise a ceramic material and a binder material. In some embodiments, the surface roughness of the insulating layer is about 0.01 μm, 0.02 μm, 0.03 μm, 0.04 μm, 0.05 μm, 0.06 μm, 0.07 μm, 0.08 μm, 0.09 μm, 0.1 μm, 0.11 μm, 0.12 μm, 0.13 μm, 0.14 μm, 0.15 μm, 0.16 μm, 0.17 μm, 0.18 μm, 0.19 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, or 2 μm, or any range of values therebetween. In some embodiments, the insulating layer has a low internal porosity, which prevents the insulating layer from denting or being compressed during the dry electrode lamination process. It has been observed that the use of spherical particles, which fit together tightly when dry, results in low internal pore space. In contrast, it has been observed that the use of non-spherical particles, even if they are small in size, form voids during a drying process, resulting in a deformable coating. In some embodiments, the density of the insulating layer is about 1.8 g/cm³, 1.85 g/cm³, 1.9 g/cm³, 1.95 g/cm³, 2 g/cm³, 2.05 g/cm³, 2.1 g/cm³, 2.15 g/cm³, 2.16 g/cm³, 2.17 g/cm³, 2.18 g/cm³, 2.19 g/cm³, 2.2 g/cm³, 2.21 g/cm³, 2.22 g/cm³, 2.23 g/cm³, 2.24 g/cm³, 2.25 g/cm³, 2.26 g/cm³, 2.27 g/cm³, 2.28 g/cm³, 2.29 g/cm³, 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm², 2.4 g/cm³, 2.5 g/cm³, or 2.6 g/cm³, or any range of values therebetween. In some embodiments, the density of the insulating layer is about 2.27 g/cm³. In some embodiments, the density of the insulating layer is greater than 1.72 g/cm³.

In some embodiments, it may be preferable that after drying the insulating layer does not, or does not substantially, adhere to adjacent layers. In some embodiments, the thickness of the insulating layer is less than or at most the thickness of a conductive coating. In some embodiments, the insulating layer does not, or does not substantially, adhere to a film (e.g., a wet or dry electrode film) applied to or disposed over the current collector during the application process. In some embodiments, the insulating layer does not, or does not substantially, adhere to a functional film (i.e., a dry battery electrode film) during a lamination process utilizing heat and pressure to adhere a functional film (i.e., a dry battery electrode film) to a conductive adhesive, which is also coated onto the current collector.

### Ceramic Material

In some embodiments, the insulating layer of the present disclosure comprises a ceramic material selected from the group consisting of boehmite, alumina, and combinations thereof. In some embodiments, the morphology of the ceramic material facilitates compact or dense packing of the ceramic, causing a higher coating density. In some embodiments, the ceramic material affords improved adhesive qualities.

In some embodiments, the ceramic material has a D₅₀ particle size distribution of, or of about, 0.01 μm, 0.02 μm, 0.03 μm, 0.04 μm, 0.05 μm, 0.06 μm, 0.07 μm, 0.08 μm, 0.09 μm, 0.1 μm, 0.11 μm, 0.12 μm, 0.13 μm, 0.14 μm, 0.15 μm, 0.16 μm, 0.17 μm, 0.18 μm, 0.19 μm, 0.2 μm, 0.3 μm, 0.4μ, 0.5μ, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, or 2 μm, or any range of values therebetween. In some embodiments, the ceramic material has a mean particle size of, or of about, 0.01 μm, 0.02 μm, 0.03 μm, 0.04 μm, 0.05 μm, 0.06 μm, 0.07 μm, 0.08 μm, 0.09 μm, 0.1 μm, 0.11 μm, 0.12 μm, 0.13 μm, 0.14 μm, 0.15 μm, 0.16 μm, 0.17 μm, 0.18 μm, 0.19 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, or 2 μm, or any range of values therebetween. In some embodiments, the ceramic material particles are spherical-shaped.

Table 1 summarizes various ceramic materials that were utilized in the insulating layer. As discussed herein, Ceramic 1 and Ceramic 2 afforded an insulating layer with the desired particle cohesion, while not adhering to electrodes.

TABLE 1
Ceramic Materials

| Ceramic No. | Material | D₅₀ (μm) | BET (m²/g) |
|---|---|---|---|
| Ceramic 1 | Alumina | 0.1 | 15 |
| Ceramic 2 | Alumina | 0.11 | 42.8 |
| Ceramic 3 | Alumina | 0.8 | 7 |
| Ceramic 4 | Alumina | 0.46 | 5.6 |
| Ceramic 5 | Alumina | 0.5 | 6.9 |
| Ceramic 6 | Alumina | >0.12 | 40 |
| Ceramic 7 | Alumina | 0.12 | 55 |
| Ceramic 8 | Alumina | 0.095 | 105 |
| Ceramic 9 | Alumina | 0.08 | 200 |
| Ceramic 10 | Alumina | 0.3 | 7.5 |
| Ceramic 11 | Alumina | 2 | 40 |
| Ceramic 12 | Alumina | 0.349 | 14 |
| Ceramic 13 | Alumina | 0.352 | 14.21 |
| Ceramic 14 | Alumina | 0.183 | 13.87 |
| Ceramic 15 | Boehmite | 0.9 | 6 |
| Ceramic 16 | Bochmite | 2.7 | 3.5 |
| Ceramic 17 | Boehmite | 1.8 | 3 |
| Ceramic 18 | Boehmite | 0.3 | 17 |
| Ceramic 19 | Boehmite | 0.07 | 250 |
| Ceramic 20 | Boehmite | 1.556 | 3.04 |
| Ceramic 21 | Boehmite | 0.977 | 5.38 |
| Ceramic 22 | Boehmite | 0.2 | 25 |

### Binder Material

In some embodiments, the binder material has a glass transition temperature or melting point such that the material does not act as an adhesive (e.g., thermal melt-laminating adhesive) during a lamination process. In some embodiments, the binder material is selected from the group consisting of polyvinylpyrrolidone (PVP), poly(N-vinylcaprolactam) (PNVCL), poly(vinyl pyrrolidone-co-caprolactam), polyglycidyl ether, poly(n-vinylacetamide) (PNVA), ethylene-acrylic acid (EAA), and combinations thereof. In some embodiments, the binder is crosslinked. In some embodiments, the binder is uncrosslinked. In some embodiments, the binder material has a glass transition temperature of, or of about, 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., or 185° C., or any range of values therebetween. In some embodiments, the binder material has a melting point of, or of about, 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., or 185° C., or any range of values therebetween.

In some embodiments, the binder material may provide sufficiently adhere to a current collector foil and also have sufficient cohesive strength between the particles in the insulating layer. In some embodiments, the binder material may be able to withstand the highly electrochemically reductive and/or oxidative conditions within an electrochemical cell (specific to the electrode current collector that it is applied to oxidative at the positive electrode, reductive at negative). In some embodiments, the binder material may be able to withstand extended contact with the solvents, salts, and other chemical species present in the electrolyte. In some embodiments, the binder material may retain, or substantially retain, adhesive and cohesive strength over the useful life of the cell.

### Coated Electrode Foil

In some embodiments, the insulating material of the present disclosure is coated onto an electrode or a coated electrode foil. In some embodiments, the coated electrode foil comprises an electrode foil and a carbon coating disposed over a portion of the electrode foil. In some embodiments, the insulating material functions as a dividing film between different electrodes. In some embodiments, the insulating material provides electrical insulation to an anode and/or a cathode. In some embodiments, the insulating material disposed on a coated electrode foil does not stick or adhere to an electrode film during the lamination process.

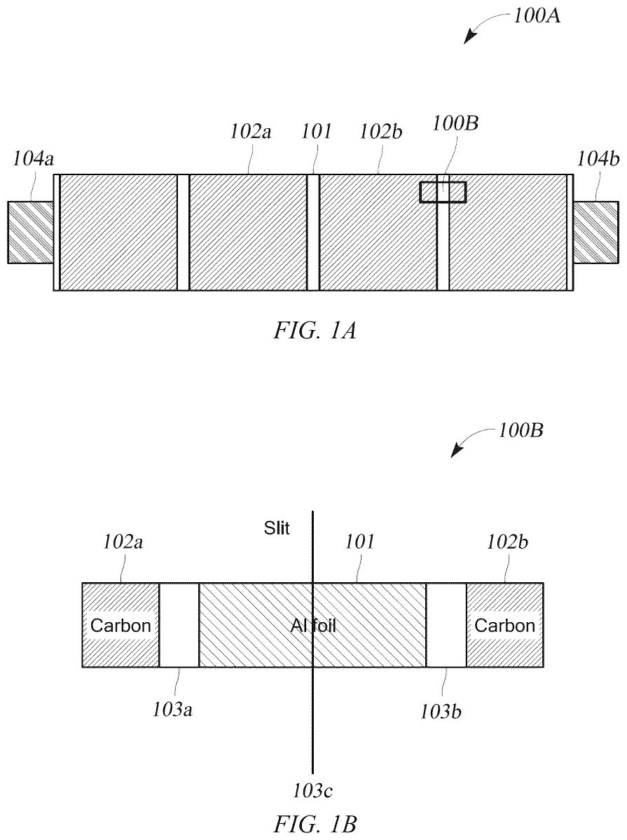

FIG. 1A illustrates the coating pattern of the coated electrode foil 100A, according to some embodiments. The coated electrode foil 100A includes a third portion of the bare foil 101 (e.g., aluminum foil), and first portions 102a and 102b comprising a carbon coating. The coated electrode foil 100A is shown with core ends 104a and 104b. FIG. 1B is an expanded view of FIG. 1A illustrating the coating pattern of the coated electrode foil 100B. The coated electrode foil 100B includes bare foil 101 (e.g., aluminum foil), first portions 102a and 102b comprising a carbon coating, and second portions 103a and 103b disposed between first portion 102a and bare foil 101 or first portion 102b and bare foil 101, respectively. In some embodiments, second portions 103a and 103b comprise the insulating material. In some embodiments, at the coated electrode foil 100 may be cut along position 103c to form multiple coated electrode foils. In some embodiments, an electrode film may be disposed over the first portions 102a and/or 102b and the carbon coatings to form an electrode. In some embodiments, the electrode film is disposed over the first portions 102a and/or 102b and adheres to the carbon coatings. In some embodiments, the electrode film is further disposed second portions 103a and/and 103b and the insulating layer. In some embodiments, the electrode film disposed second portions 103a and/and 103b and the insulating layer may be cleanly removed from the insulating layer without altering or roughening the surface of the insulating layer. In some embodiments, the electrode film does not adhere to the insulating layer, even after heat and/or pressure is applied.

### Energy Storage Device

Energy storage devices of the present disclosure include the electrolyte discussed herein, a cathode, an anode, and a housing, wherein the electrolyte, cathode and anode are disposed within the housing. In some embodiments, an energy storage device as provided herein is a lithium-ion battery. Each of the cathode and anode include an electrode film and a current collector that form the electrode.

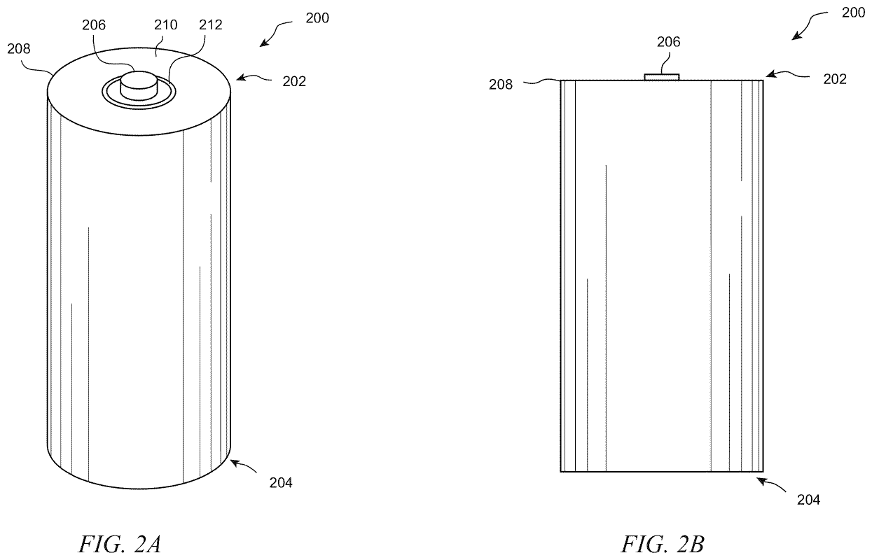

FIG. 2A illustrates a battery cell 200 in a perspective view through, and FIG. 2B illustrates battery cell 200 in a side view. With combined reference to FIGS. 2A and 2B, the battery cell 200 may be any type of a conventional battery cell which may convert chemical energy of substances stored in the battery cell 200 into electrical energy. The battery cell 200 has a first end 202 and a second end 204. The battery cell 200 has a positive terminal 206 and a negative terminal 208 towards the first end 202. The positive terminal 206 preferentially protrudes from the first end 202 the battery cell 200 to allow a contact to be made to the positive terminal 206 and differentiate the first end 202 from the second end 204, although different geometries of the positive terminal 206 may exist. The negative terminal 208 preferentially begins on the second end 204 and continues on the outer surface 210 of the battery cell 200 and wraps at least to a portion of first end 202. The portion of the battery cell 200 that wraps from the outer surface to the first end may be referred to as the “shoulder” of the battery cell 200. The negative terminal 208 preferentially is formed on the shoulder, so that connections to the negative terminal may be made on the shoulder. In other words, the negative terminal 208 preferentially exists on shoulder of the battery cell 200. An insulation region 212 may be provided on the surface 210 of the battery cell 200 such that the positive terminal 206 and the negative terminal 208 do not short due to mutual contact. The insulating region 212 may be provided through any other means as well on area of the surface 210 between the positive terminal 206 and the negative terminal 208. In alternate embodiments, the positive and negative terminals could be switched.

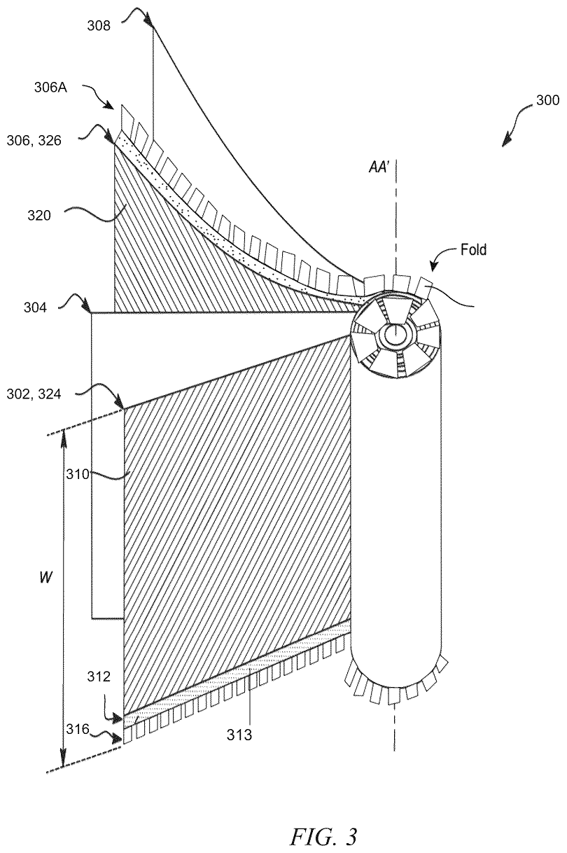

As shown in FIG. 3, a jellyroll 300 includes a first substrate 302 having a first coating 310 disposed on a side of the first substrate 302. In some embodiments, the first coating 310 may be disposed on both sides of the first substrate 302 to form a double layered electrode. In some embodiments, the first substrate 302 is embodied, preferably, in the form of a laminate that has a pre-determined amount of thickness, for example, in the range of 0.01-1 millimeter (mm). In some embodiments, the first substrate 302 comprises a current collector. In some embodiments, the current collector comprises a metallic foil. In some embodiments, the current collector comprises aluminum or copper.

In some embodiments, the first coating 310 may be an electrically conductive coating having a first amount of electrical conductivity. In some embodiments, the first coating 310 comprise an electrode film and/or a conductive carbon coating. In some embodiments, the electrically conductive coating comprises an electrode active material. In some embodiments, the conductive carbon coating is disposed over the current collector (e.g., an electrode foil). In some embodiments, the conductive carbon coating is disposed between the current collector and the electrode film, such as described with regard to FIGS. 1A and 1B. In some embodiments, the electrode film is free-standing. In some embodiments, the electrode film is absent of solvent residue. In some embodiments, the active layer or electrode film is free from, or substantially free from, any processing additives such as solvents and solvent residues resulting therefrom.

As provided herein, a “self-supporting” electrode film is an electrode film that incorporates binder matrix structures sufficient to support the film or layer and maintain its shape such that the electrode film or layer can be free-standing. When incorporated in an energy storage device, a self-supporting electrode film or active layer is one that incorporates such binder matrix structures. Generally, and depending on the methods employed, such electrode films or active layers are strong enough to be employed in energy storage device fabrication processes without any outside supporting elements, such as a current collector, support webs or other structures, although supporting elements may be employed to facilitate the energy storage device fabrication processes. For example, a “self-supporting” electrode film can have sufficient strength to be rolled, handled, and unrolled within an electrode fabrication process without other supporting elements. A dry electrode film, such as a cathode electrode film or an anode electrode film, may be self-supporting.

As provided herein, a “solvent-free” electrode film is an electrode film that contains no detectable processing solvents, processing solvent residues, or processing solvent impurities. A dry electrode film, such as a cathode electrode film or an anode electrode film that is manufactured with only dry components, may be solvent-free.

A “wet” electrode, “wet process” electrode, or slurry electrode, is an electrode or comprises an electrode film prepared by at least one step involving a slurry of active material(s), binder(s), and optionally additive(s), even if a subsequent drying step removes moisture from the electrode or electrode film. Thus, a wet electrode or wet electrode film will include at least one or more processing solvents, processing solvent residues, and/or processing solvent impurities.

In some embodiments, an electrode film includes an active cathode material. In some embodiments, the electrode active material is selected from a silicon material (e.g. metallic silicon and silicon dioxide), graphitic materials, graphite, graphene-containing materials, hard carbon, soft carbon, carbon nanotubes, porous carbon, and conductive carbon. In some embodiments, cathode active materials can comprise, for example, a metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄), chalcogenides (LiTiS₂), tavorite (LiFeSO₄F), silicon, silicon oxide (SiOx), aluminum, tin, tin oxide (SnOx), manganese oxide (MnOx), molybdenum oxide (MoO₂), molybdenum disulfide (MoS₂), nickel oxide (NiOx), and copper oxide (CuOx), or combinations thereof. The cathode active material can comprise sulfur or a material including sulfur, such as lithium sulfide (Li₂S), or other sulfur-based materials, or a mixture thereof.

In some embodiments, an electrode film includes an anode active material. In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx.). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, the first coating further comprises a binder. In some embodiments, the first coating 310 may be disposed on the first substrate 302 by any means known to persons skilled in the art. Some examples of disposing the first coating 310 onto the first substrate 302 include, but are not limited to, mechanical deposition, electromechanical deposition, electrochemical deposition, or any combination of processes known to persons skilled in the art.

Foil portion 312 of the first substrate 302, located partway along a width W of the first substrate 302, is formed, which includes insulating layer 313 and a series of lower flags 316. In some embodiments, the insulating layer 313 includes a ceramic material and a binder as described herein. In some embodiments, the insulating layer 313 may be disposed on both side of the first substrate 302. In some embodiments, the insulating layer 313 may aid to reduce or prevent electrical contact between the first substrate 302, the first coating 310 and/or the series of lower flags 316 with a second substrate 306 and/or the second coating.

As shown, as the jellyroll is formed, the lower flags 316 become wound around the central axis AA′. In some embodiments, the lower flags 316 are an exposed region of the first substrate 302 (e.g. current collector). In some embodiments, the lower flags 316 consists or consists essentially of the first substrate 302. In some embodiments, when the electrode is wound and the jellyroll is formed the series of flags are substantially interleaved such that they are substantially folded over one another, and/or tenting of the flags is substantially absent. In some embodiments, the series of flags form a concentric circular pattern when the electrode is wound. In some embodiments, the distance between each of the series of flags is about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or any range of values therebetween. In some embodiments, for example, the distance between the series of flags ranges from 5 mm to 50 mm. In further embodiments, the distance between the series of flags ranges from 5 mm to 20 mm.

An inner separator 304 is disposed over (e.g. stacked on top of) the first substrate 202. In some embodiments, the inner separator 304 is in the form of a laminate that has a pre-determined amount of thickness, for example, in the range of 1-50 micrometers (μm). In some embodiments to inner separator is or is about 1 μm, 2 μm, 3 μm, 4 μm, 5 μm, 6 μm, 7 μm, 8 μm, 9 μm, 10 μm, 15 μm, 20 μm, 30 μm, 40 μm or 50 μm, or any range of values therebetween (e.g 5-10 μm). Furthermore, in some embodiments the inner separator 304 is electrically insulative. In some embodiments, the inner separator may comprise a polymeric material. In some embodiments, the inner separator may be selected from polyethylene, polypropylene, or combinations thereof. In some embodiments, the inner separator comprises multiple separator layers. In some embodiments, the inner separator comprises micro-pores.

Further, a second substrate 306 is disposed over (e.g. stacked on top of) the inner separator 304. The second substrate 306 has a second coating 320 disposed on a side of the second substrate 306. In some embodiments, the second coating 320 may be disposed on both sides of the second substrate 306. In some embodiments, the second substrate 306 is in the form of a laminate that has a pre-determined amount of thickness, for example, in the range of 0.01-1 millimeter (mm). In some embodiments, the second substrate 306 comprises a current collector (e.g. a foil).

The second coating 320 is an electrically conductive coating having a second amount of electrical conductivity. In some embodiments, the second coating 320 may be an electrode film and/or a conductive carbon coating. In some embodiments, the electrically conductive coating comprises an electrode active material. In some embodiments, the electrode active material is a cathode active material. In some embodiments, the electrode active material is an anode active material. In certain embodiments, the second coating 320 may be similar to or the same as the first coating 310 and therefore may have similar or the same electrical conductivity. In certain other embodiments, the second coating 320 may be different than the first coating 310 and therefore may have different electrical conductivities. In some embodiments, the second coating 320 may be disposed on the second substrate 306 by any means known to persons skilled in the art. Some examples of disposing the second coating 320 onto the second substrate 306 include, but are not limited to, mechanical deposition, electromechanical deposition, electrochemical deposition, or any combination of processes known to persons skilled in the art.

An outer separator 308 may be disposed over (e.g. stacked on top of) the second substrate 306. In some embodiments, the outer separator 308 is in the form of a laminate that has a pre-determined amount of thickness, for example, in the range of 1-50 μm. Furthermore, the outer separator 308 is electrically insulative. Upon stacking the first substrate 302, the inner separator 304, the second substrate 306, and the outer separator 308 in a successive manner, the first substrate 302, the inner separator 304, the second substrate 306, and the outer separator 308 are rolled about a central axis AA′ with the first substrate 302 being closest in position to the central axis AA′.

As shown, the second substrate 306 includes a series of flags 306A which are formed from the foil in communication with the second substrate 306. These flags 306A become wound around the upper layer of the jellyroll to form a flower or artichoke shape if bent over towards the central axis AA′ as the jellyroll is being created. In some embodiments, when the electrode is wound and the jellyroll is formed the series of flags are substantially interleaved such that they are substantially folded over one another, and/or tenting of the flags is substantially absent. In some embodiments, each of the series of flags form a concentric circular pattern when the electrode is wound. In some embodiments, the distance between the series of flags is about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or any range of values therebetween. In some embodiments, for example, the distance between the series of flags ranges from 5 mm to 50 mm. In further embodiments, the distance between the series of flags ranges from 5 mm to 20 mm.

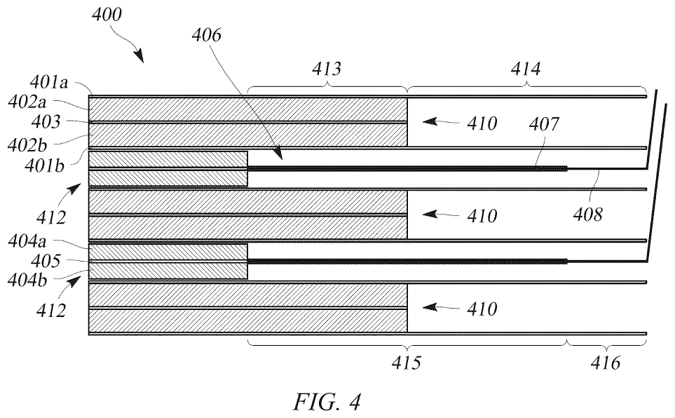

FIG. 4 illustrates a cross-sectional view of the terminal end of jellyroll 400, with anode 410 separated from cathode 412 by separators 401a and 401b. Anode 410 is shown as a dual coated anode and includes anode current collector foil 403 sandwiched between anode electrically conductive coatings 402a and 402b (e.g., conductive carbon coating and anode electrode film). Cathode 412 is shown as a dual coated cathode and includes cathode current collector foil 405 sandwiched between cathode electrically conductive coatings 404a and 404b (e.g., conductive carbon coating and cathode electrode film). Anode overhang 413 extends beyond cathode 412. The cathode current collector 405 is shown extending beyond the distal ends of the cathode electrically conductive coatings 404a and 404b, forming extended overhang 406. A portion of extended overhang 406 is coated with insulating layer 407, forming a ceramic coating portion 415 and an exposed portion 416 of extended overhang 406 forms a flag 408, wherein a portion of the flag is bent and beyond separator overhang 414 and the distal end of separators 401a and 401b.

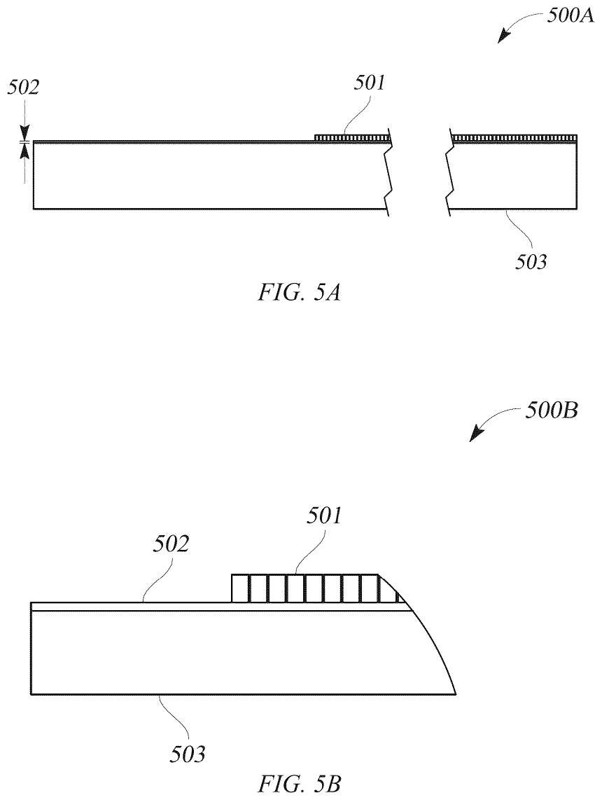

FIG. 5A shows a terminal end of an unrolled electrode 500A comprising flags 501, an insulating coating 502, and an electrically conductive coating 503 (e.g., electrode film and/or conductive carbon coating). FIG. 5B is an expanded view of FIG. 5A showing a terminal end of an unrolled electrode 500B comprising flags 501, an insulating coating 502, and an electrically conductive coating 503. The length of the ceramic material 502 measured between the flags 501 and electrically conductive coating 503 may be 2 mm, and the length of the series of flags 501 measured between the ceramic material 502 and a terminal end of the flags may be 5.5 mm, according to one embodiment. The lack of adhesion or substantial adhesion of the insulating layer may allow the insulating layer to serve as a patterning boundary to define the part of the foil.

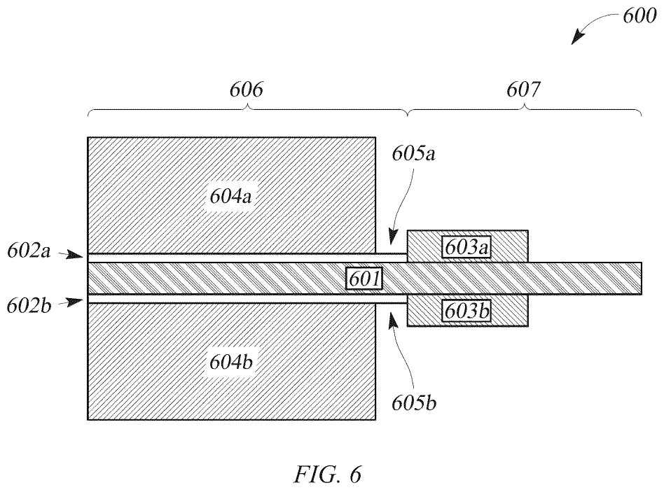

In some embodiments, the coated electrode foil includes a gap between the insulating layer and electrode film, as illustrated in FIG. 6. FIG. 6 illustrates the cross-sectional view of the coating pattern of the double-sided coated electrode 600. The coated electrode 600 includes a current collector 601, a first portion 606 comprising a top and bottom carbon coating 602a and 602b, respectively, and a top and bottom electrode film 604a and 604b, respectively, partially disposed over the top and bottom carbon coatings 602a and 602b, and a second portion 607 comprising a top and bottom insulating layer 603a and 603b, respectively. The coated electrode 600 further includes a top and bottom gap 605a and 605b disposed between the edges of the top and bottom electrode films 604a and 604b and the edges of the top and bottom insulating layers 603a and 603b, respectively. The gaps 605a and 605b are shown with exposed portions of the top and bottom carbon coatings 602a and 602b. In some embodiments, there is no, or substantial no, intermingling of the insulating layer or ceramic coating 603a and 603b and the electrode film or cathode electrode 604a and 604b along the gap 605.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (HEV), plug-in hybrid electric vehicles (PHEV), and/or electric vehicles (EV).

It will be understood that an electrolyte formulation provided herein, can be used in various embodiments with any of a number of energy storage devices and systems, such as one or more batteries, capacitors, capacitor-battery hybrids, fuel cells, or other energy storage systems or devices and combinations thereof. In some embodiments, an electrolyte additive or electrolyte including an additive described herein may be implemented in lithium ion batteries.

### Method of Manufacture

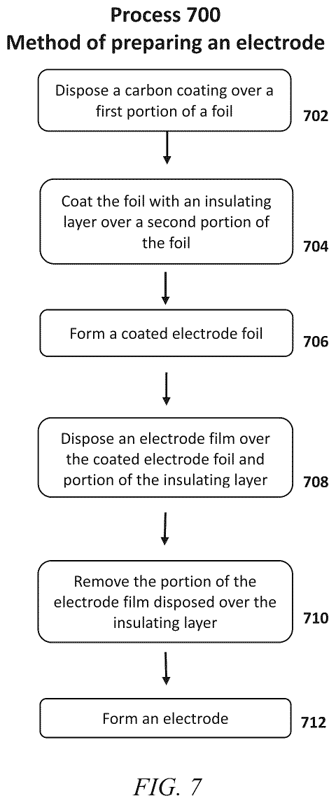

Some embodiments of the present disclosure relate to a process for preparing the coated electrode foil and/or the electrode disclosed herein. FIG. 7 is a flowchart of process 700 for preparing an electrode, according to one embodiment. The process includes disposing a carbon coating over a first portion of a foil 702 and coating a second portion of the foil with an insulating layer 704 to form a coated electrode foil 706. Once the coated electrode foil is formed, an electrode film is disposed over the coated electrode foil and over a portion of the insulating layer 708, and subsequently the portion of the electrode film disposed over the insulating layer is removed 710 to form an electrode 712. In some embodiments, the portion of the insulating layer comprises a smooth surface after the portion of the electrode film is removed. In some embodiments, the portion of the electrode film cleanly peels from the insulating layer during the disposing and removing steps.

In some embodiments, the conductive coating and insulating layer are coated side-by-side onto the foil. A dry electrode film is then placed on top of the conductive coating and insulating layer and laminated. The dry electrode sticks to the conductive coating, but does not, or does not substantially, stick to the insulating layer. The un-adhered electrode section is then cleanly peeled off and disconnected from the remainder of the adhered electrode, defining the edge of the electrode.

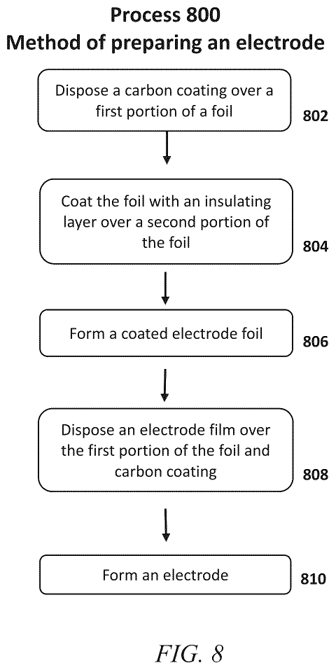

In some embodiments, the conductive coating and insulating layer are coated side-by-side onto the foil. A dry electrode film is then placed on top of the conductive coating laminated, without overlapping with the insulating layer. In some embodiments, the electrode film is cut to fit over the carbon coating and/or without overlapping with the insulating layer. In some embodiments, a distance between the edge of the electrode and the edge of the insulating layer exists when an exposed portion of the conductive coating is positioned therebetween, as shown in FIG. 8. FIG. 8 is a flowchart of process 800 for preparing an electrode, according to one embodiment. The process includes disposing a carbon coating over a first portion of a foil 802 and coating a second portion of the foil with an insulating layer 804 to form a coated electrode foil 806. Once the coated electrode foil is formed 806, an electrode film is disposed over the first portion of the foil and carbon coating 808 to form an electrode 810.

In some embodiments the ceramic coatings and dry electrode films utilized in the process for preparing the electrode disclosed herein may utilize an aqueous insulating solution and/or the insulating solution does not intermingle with the dry electrode film. Intermingling can be avoided due to the use of a dry electrode film, the removal of the electrode film from the insulating layer, and/or avoiding disposing the electrode film over the insulating layer as described herein. In some embodiments, processes that avoid intermingling include those described herein with reference to FIG. 7 and FIG. 8. In some embodiments, electrodes that avoid intermingling include those described herein with reference to FIGS. 1A-6.

In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

In some embodiments, the electrode film mixture can be calendered in a calender apparatus to form a free-standing fibrillized electrode film. In some embodiments, a calendered mixture forms a free-standing dry particle film free or substantially free from any liquids, solvents, and resulting residue therefrom. In some embodiments, the electrode film is an anode electrode film. In some embodiments, the electrode film is a cathode electrode film. In some embodiments, the process for fabricating an electrode film is a dry process, where no liquids or solvents are used and the listed raw materials are dry (e.g. one or more are dry powders) such that the resulting electrode film is free or substantially free of any liquids, solvents, and resulting residues.

In some embodiments, the insulating layer is applied using a gravure coating method as a wet ink to metallic current collector foils and dried. For high-speed gravure coating, it has been observed that the coating slurry must be regulated to a particular viscosity. It requires relative low viscosity at high shear rates, but not too low to avoid smearing. In some embodiments, the binder material includes a polymer binder. In some embodiments, the binder material does not act as a thermal melt-laminating adhesive during the temperature range of a lamination process. Generally, the coating slurry viscosity can be regulated by reducing the solids content and binder content; however, lowering the amount of the binder resulted in weaker coating properties. In some embodiments, the insulating layer wet ink comprises a solvent. In some embodiments, the solvent is an inorganic solvent, an organic solvent, or combinations thereof.

Typical wet-processed electrodes utilizing ceramic coating slurries and cathode electrode slurries require the use of the same solvent system, such as both solvent systems being organic solvents or both solvent systems being aqueous. In such wet-processed electrodes, the ceramic coating and cathode electrode slurries are deposited edge-to-edge, resulting in intermingling of the two slurries due to the similar solvent systems utilized. In addition, water-based solvent systems for the insulating layer are generally not able to be utilized in typical wet-processed electrodes because the slurry cast electrode film generally requires the use of organic solvents. The use of both water-based and organic-based coatings in the same dryer would result in water moisture reacting with the cathode material and negatively impacting the cathode activity. In addition, edge-to-edge contact between aqueous and organic-based coatings may cause gelation of the coatings and result in poor edge quality.

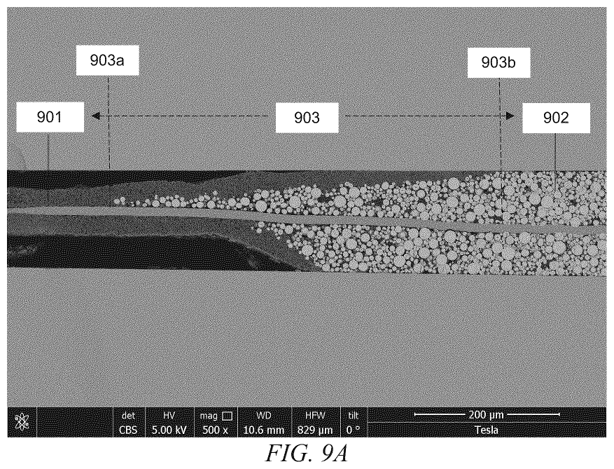

FIG. 9A is a scanning electron microscope (SEM) image of a typical wet-processed electrode utilizing organic solvent systems. As shown in FIG. 9A, a solvent-based ceramic slurry 901 intermingled with a solvent-based cathode slurry 902 resulting in a wide overlapping region 903, with overlap endpoints 903a and 903b. FIG. 9B is a top view photographic image of a typical wet-processed electrode. As visually illustrated in FIG. 9B, the overlapping region of the two organic slurries covered a wide region of the wet-processed electrodes, ultimately resulting in lower yields of the coated electrodes prepared by a wet-process.

In some embodiments, an energy storage device is created such that one electrode (e.g., anode) is larger than and overhangs the other electrode (e.g., cathode). Such electrode overhangs may avoid yield losses. In some embodiments where there is no, or is substantially no, overlap and/or intermingling of the insulating layer and electrode film (e.g., cathode electrode film), the boundary of the electrode film is easier to identify and therefore improves the ability to form a counter electrode (e.g., anode electrode) with an overhang. In some embodiments, a vision system (e.g., a camera) is able to identify the boundary of the electrode film and/or amount of cathode material.

### EXAMPLES

Insulating electrode edge coating compositions of the present disclosure may be prepared utilizing the methods disclosed herein. Additional embodiments are disclosed in further detail in the following examples, which are not in any way intended to limit the scope of the claims.

### Example 1—Production Formulation

Formulations of the electrically insulative material of the present disclosure were manufactured as follows. First, a ceramic powder was dispersed in water. Next, a binder resin and at least one crosslinker were added to the solution. A wetting agent and deionized water were added and mixed in a one-pot solution at a low shear rate. Table 2 summarizes the production formulation of the electrically insulative material of the present disclosure.

TABLE 2
Production Formulation Summary

| Material | % in slurry | Weight % in dry coating |
|---|---|---|
| Ceramic raw material | 68 | 95 |
| Binder 1 | 6 | 4 |
| Binder 2 | 0.14 | 0.5 |
| Surfactant | 0.15 | 0.5 |
| Deionized water | 26 | — |

### Example 2—Binder Coupon Sample Preparation

Coupon samples of the binder were prepared by drying the water-based binder solutions in PTFE dishes. Uncrosslinked samples used Binder 1 as-is. Crosslinked samples used a mixture of Binder 1 and Binder 2 in 9:1 wt./wt. ratio. After the water was removed under vacuum at about 80° C., approximately 100 mg coupons of the dried binder films were cut out and weighed by analytical balance.

### Example 3—Binder Aging Experiment in Electrolyte

Coupon samples made by the method of Example 2 were immersed in 20 mL of Li-ion battery electrolyte (˜1.2 m LiPF₆ in EC:DMC:EMC (25:70:5)+1% VC+2% FEC) in sealed polypropylene containers. The tops of the containers were covered in parafilm, and the containers were stored in the dry room at 17° C. to prevent water ingress.

The binder films were removed from the electrolyte periodically to measure the amount of electrolyte uptake in mass by the films. The excess electrolyte was shaken off, and any unabsorbed/swelled electrolyte on the surface of the coupons was removed by Kimwipes. The films were weighed on an analytical balance, and mass increases from electrolyte uptake were measured. All processes and handling of films and electrolytes were performed in a dry room. Measurement points were taken at 1, 2, 3, 6, 7, 8, 15, 41, 98, and 126 days.

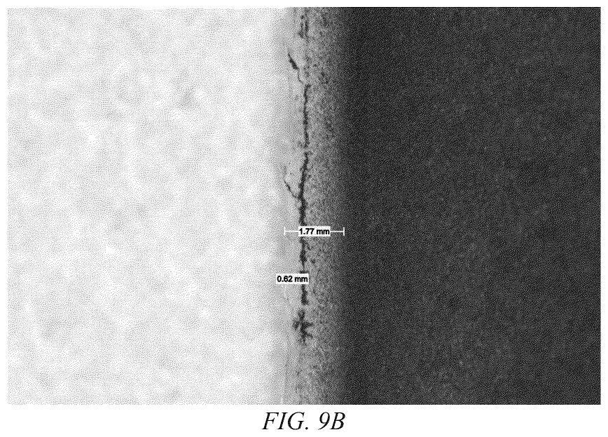

FIG. 10 summarizes the electrolyte uptake factor of the aged electrolytes with crosslinked and uncrosslinked binders and demonstrates that the use of crosslinked binders decreased electrolyte uptake, compared to uncrosslinked binders. For example, after 120 days, the electrolyte uptake factor of the aged electrolytes with uncrosslinked binders was about 1.35, while the electrolyte uptake factor of the aged electrolytes with crosslinked binders was about 1.25. Two samples of each film were tested.

### Example 4—Binder Electrochemical Stability

Tests were conducted using the typical formulation for the ceramic coating (e.g., 24 wt. % ceramic and 2.4 wt. % binder). For binder-only films, only binder with no ceramic was used. For crosslinked films, Binder 2 was added 9:1 wt./wt. Binder 1:Binder 2 ratio). Films were coated onto Al foil, stainless steel disks, or directly onto stainless steel coin cell caps by doctor blade and dried in a vacuum oven. Films were approximately 2 μm thick. Coin cells were built using the films (working electrode), a polymer separator, lithium metal counter electrode, and standard electrolyte. The cells were tested using cyclic voltammetry with a voltage window of 2.5-4.4 V vs. Li/Lit, with a voltage sweep rate of 0.5 mV/s, for 20 cycles. Stainless steel disks were utilized to reduce background signals generally produced from alloy aluminum foil.

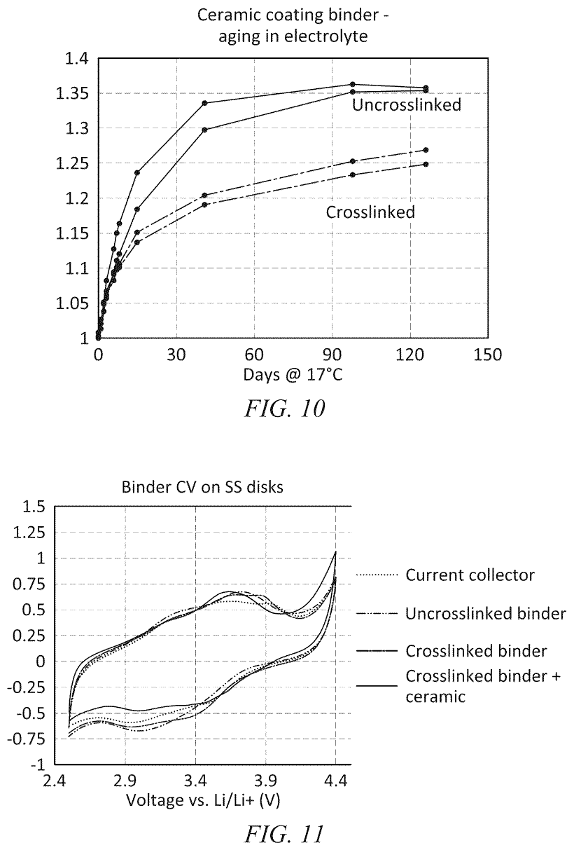

FIG. 11 is a line graph showing the current v. voltage of the electrodes after ten cycles. Regardless of the substrate, no significant electrochemical activity difference was observed across all cycles between all films, demonstrating the electrochemical stability of the crosslinked binder. In addition, no additional peaks were observed at this voltage range, again signify the electrochemical stability of the binder and ceramic particles. The detected peaks may be related to FeF₂ oxidation/reduction, which arise from reaction with residual HF in the electrolyte.

### Example 5—Binder Differential Scanning Calorimetry (DSC)

Binder films were dried in PTFE dishes at 80° C. under vacuum. Crosslinked samples were prepared similarly as above. Approximately 5-10 mg of solid binder were used for a standard differential scanning calorimetry (DSC) measurements. TA Instruments Q50 DSC was utilized, with a sweep from room temperature to 200° C., down to 0° C., and back to 200° C., at 10° C./min.

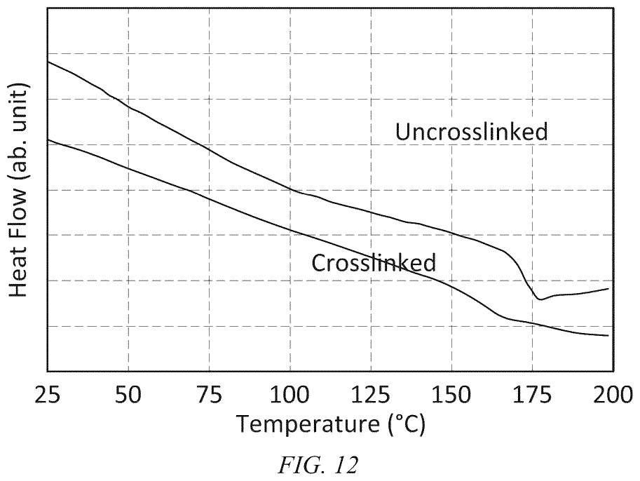

FIG. 12 showing the DSC curves of the crosslinked and uncrosslinked binders. The crosslinked sample has a slightly lower T_{g} of about 160° C., while the uncrosslinked sample has T_{g} of about 172° C. Compared to typical waterborne acrylate binders with a T_{g} of about 0° C. to 30° C., such high glass transition temperatures enables the high temperature lamination processes by avoiding softening of the binder in the coating, and as such, preventing sticking of active material films.

### Example 6—Ceramic Interparticle Cohesion

Ceramic inks were made via standard mixing process with various compositions. Total solids of these inks were varied as the same inks were used to build the viscosity model. With regards to the dried coating properties, it was observed that the total solids utilized were irrelevant, as the defining property of the coating strength is the amount of binder relative to the ceramic. Here, various films were coated to about 5 μm thickness on Al foil and dried in a vacuum oven at 110° C. overnight. The amount of the binder was modulated from 0-10% of the ceramic mass.

Coatings on Al foil were applied to a steel block with strong double-sided tape. Cohesive strength was measured by using 19 mm width Scotch tape (“Magic tape”). The tape was applied by hand to the coating surface and pressure was applied to the tape via a rubber roller. The tape was peeled off at a 180-degree angle, at a rate of 12 in/min, via a standard peel test apparatus, an Instron load frame with custom fixtures. The peel strength was measured by averaging the force required to peel the tape over a period of 15 seconds. The tape was also inspected qualitatively, recording whether or not particles were visible on the tape after peeling.

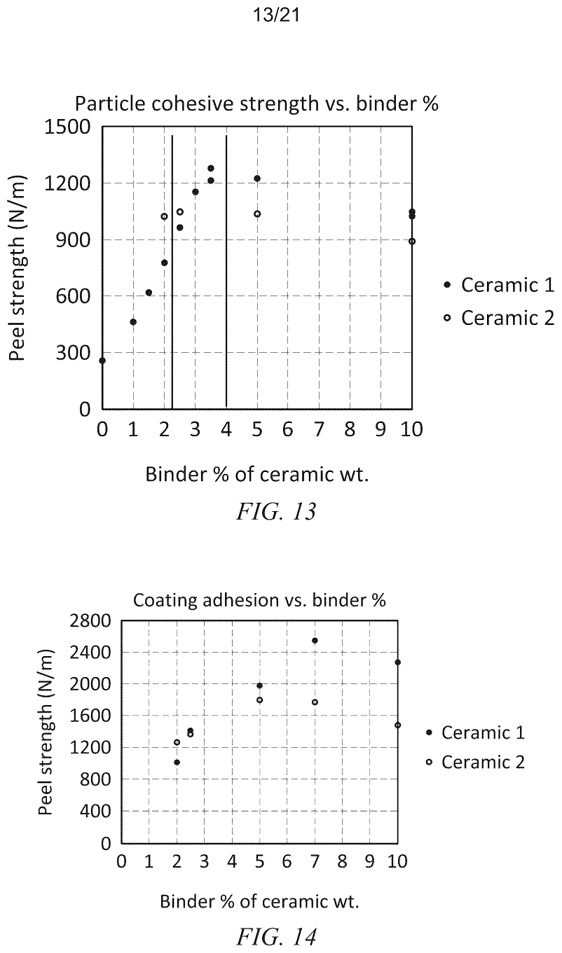

FIG. 13 is a graph of cohesion strengths of the ceramic particles with various binders as a function of the binder percentage. When the amount of the binder was about 4% or less of the ceramic mass, particles were observed on the tape, and when the amount of the binder was greater than 4% of the ceramic mass the cohesive strength of the coating exceeded the adhesive strength of individual particles to the tape.

### Example 7—Ceramic Coating Adhesion

Adhesive strength was measured by a tape with a stronger pressure-sensitive adhesive (PSA). Adhesion strength was measured using the same 180-degree angle peel test with the same equipment and methods as the cohesion measurements disclosed herein. Adhesive failure of the coating was visually observable, as bare Al foil became visible after the coating was removed from the foil surface. In this case, the thicker PSA of the tape is able to penetrate into the surface of the coating and have a higher adhesion compared to the Scotch tape, causing weaker coatings with lower binder amounts to adhesively fail.

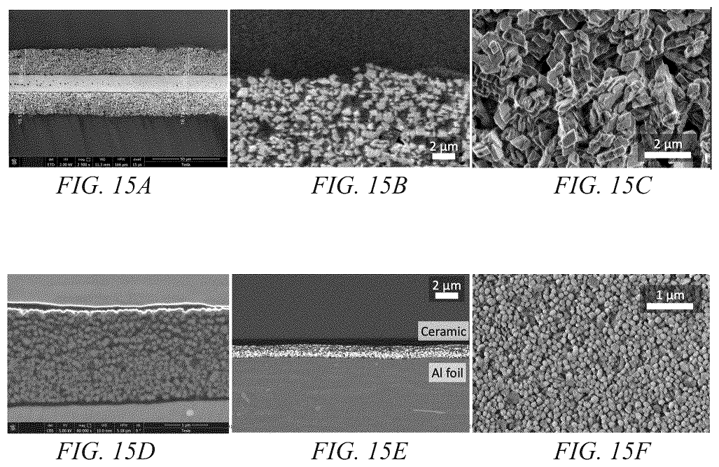

FIG. 14 is a graph of the cohesion strengths of the ceramic coating as a function of binder percentage. It was observed that the morphology of ceramic plays a key role in the adhesive strength of the coating. For example, Ceramic 1 failed with 7% of ceramic wt. binder. Ceramic 2 passed with 5% of ceramic wt. binder. Although both these ceramics have similar particle size distributions, Ceramic 2 is much more spherical than Ceramic 1. Without being bound to theory, it is believed that spherical ceramics afford improved adhesive qualities than non-spherical ceramics as a result of a better packing of the ceramic causing a higher coating density.

In addition, when a standard acrylic binder at 5% wt. of the ceramic was coated on aluminum, the coating fully adhesively delaminated from the foil surface, indicating the superiority of the insulating layer binder over typical binders for separator ceramic coatings, for adhesion on aluminum foil.

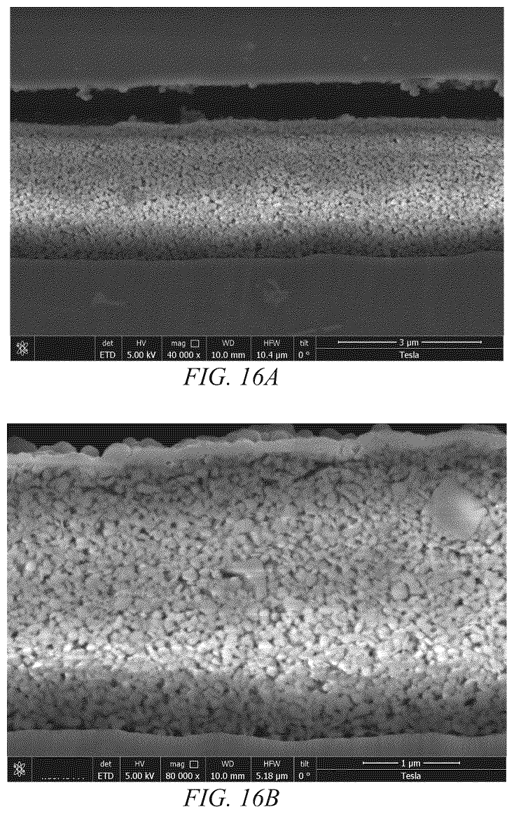

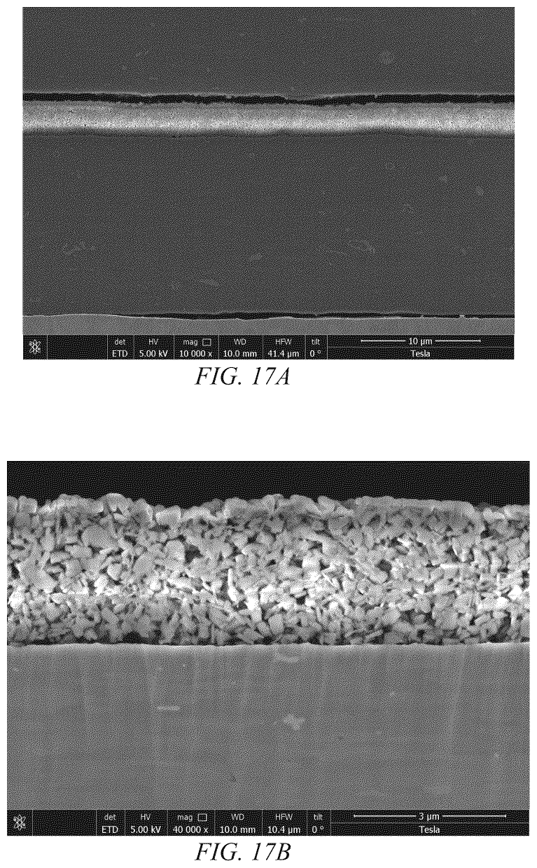

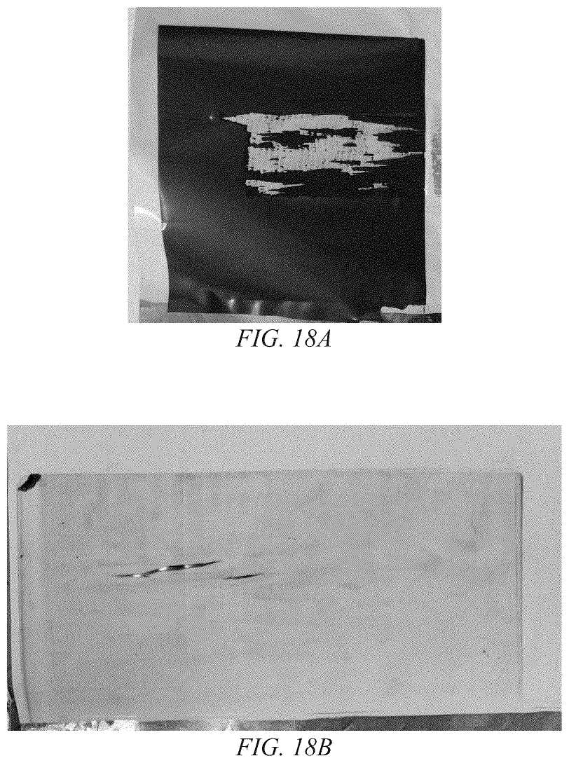

As shown in FIGS. 15A-15C, typical insulating layers utilize large, non-spherical particles with rough surfaces. In contrast, the insulating layer of the present disclosure utilize small, spherical-shaped particles, with smooth surface, as shown in FIGS. 15D-15F. In addition, FIGS. 16A and 16B show scanning electron microscope (SEM) images of fully formulated coatings including Binder 1, Binder 2, and a ceramic material comprising a D50 particle size distribution of about 0.2 μm. FIGS. 17A and 17B show scanning electron microscope (SEM) images of fully formulated coatings including Binder 1. Binder 2, and a ceramic material comprising a D50 particle size distribution of about 0.3 μm. As shown in FIGS. 16A and 16B and FIGS. 17A and 17B, fully formulated coatings with smooth surfaces have been prepared utilizing ceramic material with a D50 particle size distribution of up to about 0.3 μm.

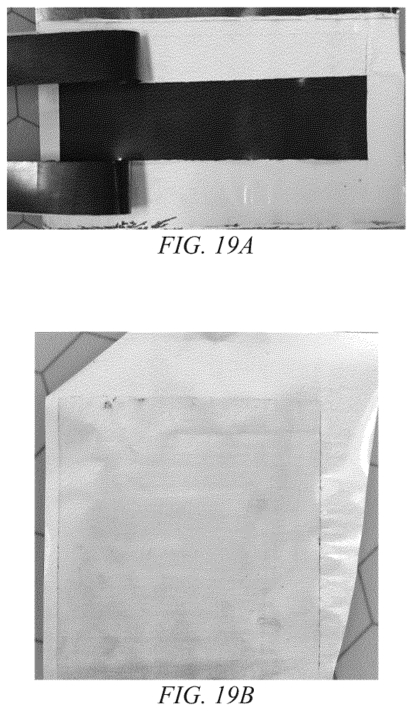

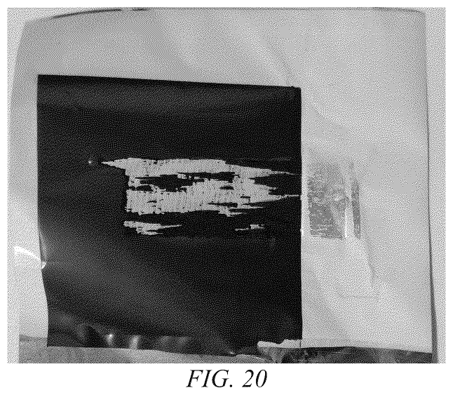

Critically, during electrode fabrication, the edge coating insulating layer of the present disclosure cleanly peeled from the electrode active material layer. FIGS. 18A and 18B are images of lamination results utilizing typical insulating layers. Typical insulating layers adhered to the coating during the application process and stuck to the electrode active material layer. As a result, typical insulating layers did not cleanly peel from the electrode active material layer, thus damaging the electrode, as seen in FIGS. 18A and 18B. In contrast, FIGS. 19A and 19B demonstrated that utilizing the insulating layer of the present disclosure did not adhere to the coating during the application process and cleanly peeled from the electrode active material layer. As such, the insulating layer of the present disclosure did not damage the electrode, as seen in FIGS. 19A and 19B.

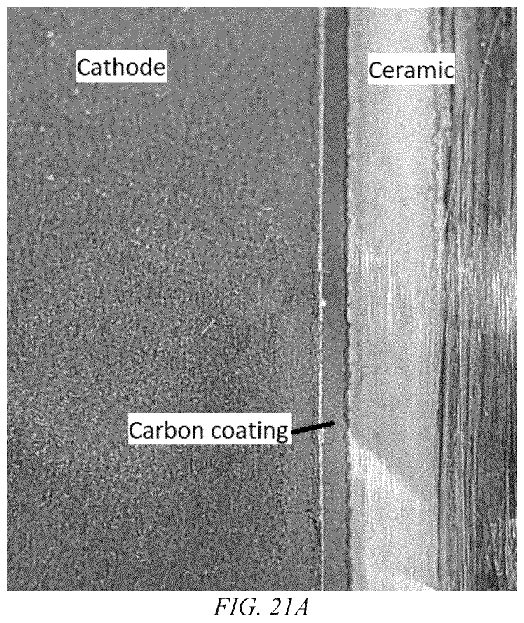

Further, it was observed that adding 2% wt. of ammonium polyacrylate as a dispersant to the insulating layer composition of the present disclosure caused lamination to worsen, as seen in FIG. 20. In addition, electrode fabrication failed when an unknown dispersant was added to the same ceramic by the supplier. This suggests that the low glass transition temperature of the polyacrylate may cause the electrode to stick to the insulating layer.

### Example 8—Gap Formation Between Insulating Layer and Electrode Film

A cathode coated electrode was prepared by a process similar to that described in FIG. 8 by disposing a carbon coating over the first portion of an aluminum foil and coating the foil with an insulating layer over the second portion of the foil. An electrode film was disposed over the first portion of the foil and the carbon coating, forming a coated electrode with a gap disposed between the electrode film and the second portion of the foil. The cathode was composed of active material (e.g., NMC, NCA), a carbon material, and a binder.

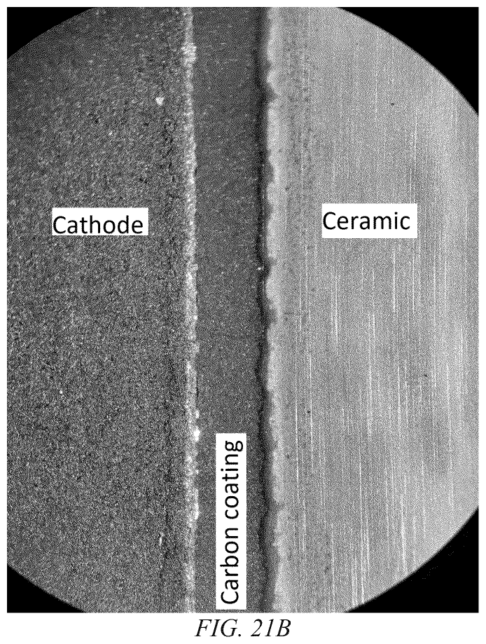

FIG. 21A is a photographic top view image of the coated cathode electrode with a gap between the electrode film and an insulating layer, and FIG. 21B is an expanded view of FIG. 21A. As shown in FIGS. 21A and 21B, the gap between the electrode film and the insulating layer where the carbon coating lies is visible. Such a visual gap may be easily identified by a vision system, thereby facilitating the production of a complementary anode electrode and/or anode electrode film with an overhang beyond the edges of the cathode electrode film.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The headings provided herein, if any, are for convenience only and do not necessarily affect the scope or meaning of the devices and methods disclosed herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A coated electrode foil, comprising:
a foil comprising a first portion, a second portion and a third portion;
a carbon coating disposed over the first portion of the foil; and
an insulating layer disposed over the second portion of the foil, wherein the insulating layer comprises:
a ceramic material comprising a D50 particle size distribution range from about 1 nm to about 500 nm; and
a high glass transition temperature binder.

2. The coated electrode foil of claim 1, wherein the high glass transition temperature binder has a glass transition temperature of at least about 140° C.

3. The coated electrode foil of claim 1, wherein the ceramic material comprises a powder selected from the group consisting of an alumina powder, a boehmite powder, and combinations thereof.

4. The coated electrode foil of claim 1, wherein the ceramic material comprises a D50 particle size distribution range from about 0.1 μm to about 0.3 μm.

5. The coated electrode foil of claim 1, wherein the high glass transition temperature binder comprises of at least one of polyvinylpyrrolidone (PVP), poly(N-vinylcaprolactam) (PNVCL), poly(vinyl pyrrolidone-co-caprolactam), poly(n-vinylacetamide) (PNVA), ethylene-acrylic acid (EAA), or polyglycidyl ether.

6. An electrode, comprising:
the coated electrode foil of claim 1; and
an electrode film disposed over the first portion of the foil.

7. The electrode of claim 6, wherein the third portion of the coated electrode foil comprises a series of flags.

8. The electrode of claim 7, wherein the electrode is in a wound configuration and the series of flags are substantially interleaved.

9. The electrode of claim 7, wherein the series of flags form a concentric circular pattern.

10. The electrode of claim 7, wherein a distance between the series of flags ranges from 5 mm to 50 mm.

11. The electrode of claim 10, wherein the distance between the series of flags ranges from 5 mm to 20 mm.

12. The electrode of claim 6, further comprising a gap disposed between the electrode film and the insulating layer.

13. An energy storage device, comprising:
the electrode of claim 6;
a second electrode; and
a separator disposed between the electrode and second electrode;
an electrolyte; and
a housing, wherein the electrode, second electrode, separator and electrolyte are disposed within the housing.

14. The energy storage device of claim 13, wherein the electrode is a cathode and the second electrode is an anode.

15. A method of preparing an electrode, comprising:
coating a foil comprising a first portion and a second portion with an insulating layer over the second portion to form a coated electrode foil, wherein a carbon coating is disposed over the first portion of the foil;
disposing an electrode film over the coated electrode foil, wherein a portion of the electrode film is disposed over the insulating layer; and
removing the portion of the electrode film disposed over the insulating layer to form an electrode.

16. The method of claim 15, wherein the portion of the insulating layer comprises a smooth surface after the portion of the electrode film is removed.

17. The method of claim 15, wherein the portion of the electrode film cleanly peels from the insulating layer during the disposing and removing steps.

18. The method of claim 15, further comprising visually identifying the boundary of the electrode film and forming a counter electrode with an overhang extending beyond the electrode.

19. An insulating material, comprising:
a ceramic material comprising a D50 particle size distribution range from about 1 nm to about 500 nm; and
a high glass transition temperature binder.

20. The insulating material of claim 19, wherein the ceramic material comprises the D50 particle size distribution range from about 0.1 μm to about 0.3 μm.

21. A method of preparing an electrode, comprising:
coating a foil comprising a first portion and a second portion with an insulating layer over the second portion to form a coated electrode foil, wherein a carbon coating is disposed over the first portion of the foil; and
disposing an electrode film over the first portion of the foil and the carbon coating to form an electrode.

22. The method of claim 21, further comprising cutting the electrode film prior to disposing the electrode film over the first portion of the foil and the carbon coating.

23. The method of claim 21, wherein the coating the foil comprises disposing an aqueous insulating solution over the second portion.

24. The method of claim 21, further comprising forming a gap disposed between the electrode film and the second portion.

25. The method of claim 24, further comprising identifying the gap and forming a counter electrode with an overhang extending beyond the electrode.
